(19) United States
(12) Patent Application Publication
(10) Pub. No.: US 2025/0316114 A1
(43) Pub. Date: Oct. 9, 2025

(54) METHOD FOR GENERATING ACCURATE ANNOTATION MAPS

(71) Applicant: AEYE Health Inc., New York, NY (US)

(72) Inventors: Idan BRESSLER, Tel Aviv (IL); Amit WOHL, Tel Aviv (IL); Danny MARGALIT, Ramat Gan (IL); Zack DVEY AHARON, Tel Aviv (IL)

(21) Appl. No.: 18/626,496

(22) Filed: Apr. 4, 2024

(51) Int. Cl. G06V 40/18; G06V 10/26; G06V 10/32; G06V 10/34; G06V 10/764; G06V 10/86; G06V 20/70

(52) U.S. Cl. CPC G06V 40/193; G06V 10/26; G06V 10/32; G06V 10/34; G06V 10/764; G06V 10/86; G06V 20/70; G06V 40/197; G06V 2201/03

(57) ABSTRACT

The present invention discloses a method and a system for generating accurate classification of veins and arteries in a blood vessel (BV) annotation map.

### FIELD OF THE INVENTION

The present invention is in the field of methods and systems in image processing and usage thereof.

### BACKGROUND OF THE INVENTION

Retinal imaging is a valuable diagnostic tool for assessing the health status of a subject with diseases, disorders, or conditions that exhibit changes in the retina. Examples of diseases that exhibit changes in retina blood vessels include Diabetic Retinopathy, Hypertensive Retinopathy, and Retinitis Pigmentosa.

The creation of a blood vessel (BV) annotation map from a retinal image using an algorithm can reduce noise in the retinal image and enhance detection capabilities. The primary limitation in creating a BV annotation map lies in accurately distinguishing between veins and arteries within the BV annotation map.

Therefore, there is an imminent need for an algorithm capable of producing an accurate BV annotation map, accurately defining segments within the BV annotation map as veins or arteries. This will significantly enhance the accuracy of diagnosing subjects in the early stages of a disease, disorder, or condition.

### SUMMARY OF THE INVENTION

According to one aspect of the present invention, there is provided a method (100) for generating an accurate classification of veins and arteries in a blood vessel (BV) annotation map comprising steps of: (a) receiving (110) BV annotation map, veins annotation map, arteries annotation map, and disc annotation map; (b) preprocessing (120) the annotation maps configured to generate an accurate classification of veins and arteries in a BV annotation map; and (c) overlaying (160) the BV map on top of a vein, artery, or both maps to determine if a given segment on the BV annotation map is a vein or an artery; wherein the preprocessing step (120) comprises (i) normalizing (130) the annotation maps; (ii) skeletonizing (140) the BV annotation map, the arteries annotation map, or the veins annotation map, including any combination thereof; and (iii) fragmenting (150) the BV annotation map, the arteries annotation map, or the veins annotation map, including any combination thereof.

In some embodiments, the method corrects classification errors of veins, arteries, or both in the BV map.

In some embodiments, the annotation maps are produced from a retinal image, by algorithms configured to generate the BV annotation map, the veins annotation map, the arteries annotation map, and the disc annotation map, including any combination thereof.

In some embodiments, the normalizing (130) comprises an image resizing step (134).

In some embodiments, the normalizing step (130) further comprises a removal step of disc area (136) from the BV map using a disc annotation map.

In some embodiments, the fragmenting step (150) comprises a graph node blackening step (154).

In some embodiments, the fragmenting step (156) further comprises a removal of small object step.

In some embodiments, the skeletonizing step (140) further comprises a graph creation and a cleaning step (142).

In some embodiments, the graph creation and cleaning step (142) comprises a removal of self-loops step (144), a removal of small objects step (146), or both.

In some embodiments, the method further comprises a re-adding step (164) configured to add removed areas around the nodes.

In some embodiments, the method further comprises removal of small objects step (166) from resulted BV map.

In some embodiments, the determination is done by segment pixel count.

According to one aspect of the present invention, there is provided a system for generating an accurate classification of veins and arteries in a blood vessel (BV) annotation map comprising (i) computer-implemented method (100) for accurately classifying veins and arteries in a blood vessel (BV) annotation map; (ii) a computer or hardware platform for running the software; (iii) a graphic processing unit having high computational power and resources to execute algorithms; and (iv) display monitor for visualizing the generated BV annotation map.

In some embodiments, the computer-implemented method (100) comprises (a) receiving (110) BV annotation map, veins annotation map, arteries annotation map, and disc annotation map; (b) processing (120) the annotation maps; and (c) overlaying (160) the BV map on top of a vein, artery, or both maps to determine if a given segment on the BV annotation map is a vein or an artery; wherein the preprocessing step (120) comprises (i) normalizing (130) the annotation maps; (ii) skeletonizing (140) the BV annotation map, arteries annotation map, and veins annotation map; and (iii) fragmenting (150) the BV annotation map, arteries annotation map, and veins annotation map.

In some embodiments, the computer-implemented method (100) corrects classification errors of veins, arteries, or both in the BV map.

In some embodiments, the normalizing step (130) comprises an image resizing step (134), and optionally a removal step of disc area (136) from the BV map using a disc annotation map.

In some embodiments, the fragmenting step (150) comprises a graph node blackening step (154), and optionally a removal of small object step (156).

In some embodiments, the skeletonizing step (140) further comprises a graph creation and a cleaning step (142); the graph creation and cleaning step comprises a removal of self-loops step (144), a removal of small objects step (146), or both.

In some embodiments, the computer-implemented method further comprises a re-adding step (164) configured to add removed areas around the nodes, a removal of small objects step (166) from resulted BV map, or both.

In some embodiments, the determination is done by segment pixel count.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The presently disclosed subject matter may be more clearly understood upon reading of the following detailed description embodiments of non-limiting exemplary embodiments thereof, with reference to the drawings.

The following detailed description of embodiments of the presently disclosed subject matter refers to accompanying drawings. Dimensions of components and features shown in figures are chosen for convenience or clarity of presentations and are not necessarily shown to scale. Wherever possible, the same reference numbers will be used throughout the drawings and the following description to refer to the same and like parts.

FIG. 1 is a flow chart of the method of the invention, according to some embodiments of the invention.

FIG. 2A-2E are images and annotation maps of a retina (2A) retinal image, (2B) retinal blood vessel (BV) annotation map, (2C) retinal arteries annotation map, (2D) retinal veins annotation map, and (2E) an optic disc annotation map.

FIG. 3 is a BV annotation map after the removal of optic disc, according to some embodiments of the invention.

FIG. 4 is a BV annotation map after the skeletonizing step, according to some embodiments of the invention.

FIG. 5A-5B are BV annotation maps after the fragmenting step (5A) BV annotation map after the removal blackening step, and (5B) BV annotation map after the removal of small objects, according to some embodiments of the invention.

FIG. 6 a BV map annotation obtained using the method of the invention, according to some embodiments of the invention.

### DETAILED DESCRIPTION OF THE PREFERRED EMBODIMENTS

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Further embodiments and the full scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

As used herein, the term “retinal image” refers to a visual presentation of the inner surface of the eye retinal. In some embodiments, the retinal image is essentially a result of light patterns captured and processed by a retina. In some embodiments, the retinal image is a 2D presentation of an image formed on the retina such as fundus photography through the refraction of light by the cornea and lens. Retinal imaging can be obtained by various imaging technologies, non-limiting examples of imaging technologies include but are not limited to fundus photography, optical coherence tomography, or scanning laser ophthalmoscopy.

As used herein, the term “annotation map” refers to a graphical representation or visual representation (map) of an image or dataset where specific objects, regions, or features are marked, labeled, or annotated. The terms “annotation map” and “map” are used interchangeably. Annotation maps refer to an artery annotated map, a vein annotated map, a blood vessel (BV) annotation map, or a disc annotation map, including any combination thereof.

As used herein, the term “fundus” refers to the posterior part of the eye, including the retina, optic disc, and blood vessels. The examination of the fundus is a well-known procedure in eye care to assess the health of a retina and diagnose different medical conditions, disorders, or diseases.

As used herein, the term “thin topological map” refers to a decrease in the pixelization of the blood vessel segment observed in the image.

As used herein, the term “not-overlay” refers to finding the smallest enclosing circle on the disc annotation map, and removing it from the center of the disc to the smallest enclosing circle. As refer herein “closing circle” refers to the smallest circle that encompasses the entire disc shape.

The terms “optic disc” and “disc” are used interchangeably, and refer to the optic nerve head, which is located at the back of the eye. The disc is the point where the optic nerve exits the eyeball and enters the brain.

As used herein the term “normalized pixel count” refers to a pixel count divided by an image size, width×length.

As used herein, the term “about” refers to a range of approximately ±10%.

As used herein, the term “substantially” refers to at least 60%, at least 70%, at least 80%, at least 85%, or at least 90%, including any range or value in between.

According to one aspect of the invention there is disclosed a method (100) for generating an accurate classification of veins and arteries in a blood vessel annotation map comprising (i) receiving (110) BV, veins, arteries, and disc annotation maps, (ii) preprocessing (120) the annotation maps configured to generate an accurate classification of veins and arteries in a BV annotation map, and (iii) overlaying (160) the BV annotation map on top of a vein, artery or both maps to determine if a given segment on the BV annotation map is a vein annotation map or and an artery annotation map.

In some embodiments, the preprocessing step (120) of the annotation maps comprises a normalizing step (130), a skeletonizing step (140), and a fragmenting step (150). In some embodiments, the normalizing step (130), the skeletonizing step (140), and the fragmenting step (150) are sequential. In some embodiments, the normalization step (130) is prior to the skeletonization step (140). In some embodiments, the skeletonization step (140) is prior to the fragmenting step (150).

In some embodiments, the normalizing step (130) comprises an image resizing step (134). In some embodiments, the image resizing step (134) re-sizes the width×length of an annotation map. In some embodiments, the width×length is measured in pixels. A person skilled in the art would appreciate that the width×length is determined by the constrains and requirements of the computational resources, for example, large images require more computational resources for processing. In some embodiments, the re-image sizing step (134) requires a balance between image resolution and computational processing speed. In some embodiments, the re-sized image can range from an actual image size to 256×256. In some embodiments, non-limiting examples of re-sized image width×length include but are not limited to 1027×768, 768×768, 768×640, 640×512, 512×512, 480×480, 448×448, 384×384, or 352×352, including any value in between. In some embodiments, the re-sized image is 512×512.

In some embodiments, all annotation maps, BV, vein, artery, and disc annotation maps are re-sized. In some embodiments, the image re-sizing step is performed on all annotation maps. In some embodiments, the steps following the re-sizing step, are conducted on a re-sized BV annotation map. In some embodiments, the steps following the re-sizing step are optionally conducted on the re-sized vein annotation map and the re-sized artery annotation map.

In some embodiments, the normalizing step (130) further comprises a removal of any individual connected component step (135). In some embodiments, the removal of any individual connected component step (135) is conducted after the image resizing step (134).

In some embodiments, the any individual connected components of a normalized image is characterized by a normalized pixel count of at most 8*10⁻⁴, at most 7*10⁻⁴, at most 6*10⁻⁴, or at most 7*10⁻⁴, and between 5*10⁻⁶ and 8*10⁻⁴, between 5*10⁻⁶ and 7*10⁻⁴, or between 5*10⁻⁶ and 6*10⁻⁴, including any range or value in between. In some embodiments, any individual connected components are characterized by a normalized pixel count of at most 8*10⁻⁴, at most 7*10⁻⁴, at most 6*10⁻⁴, or at most 7*10⁻⁴, including any range or value in between. In some embodiments, the any individual connected components are characterized by a normalized pixel count of between 5*10⁻⁶ and 8*10⁻⁴, between 5*106 and 7*10⁻⁴, or between 5*10⁻⁶ and 6*10⁻⁴, including any range or value in between.

In some embodiments, the any individual connected components of a 512×512 image is characterized by a pixel count of at most 150, at most 120, at most 100, or at most 75, and between 1 and 150, between 1 and 125, or between 1 and 100, including any range or value in between. In some embodiments, any individual connected components are characterized by a pixel count of at most 150, at most 120, at most 100, or at most 75, including any range or value in between. In some embodiments, the any individual connected components are characterized by a pixel count of between 1 and 150, between 1 and 125, or between 1 and 100, including any range or value in between.

In some embodiments, the normalizing step (130) further comprises a removal of a disc area step from the maps (136). In some embodiments, the removal of the disc (136) is done by a not-overlay of the maps with the disc annotation map and removing the disc area. In some embodiments, the not-overlay refers to finding a smallest enclosing circle on the disc annotation map, and removing the smallest enclosing circle from the annotation maps. In some embodiments, the removal of the disc (136) reduces signal-to-noise ratio. In some embodiments, the removal of the disc (136) reduces processing time of the image. In some embodiments, the removal of the disc (136) reduces signal-to-noise ratio and processing time of the image.

In some embodiments, the normalizing step (130) is performed on an annotation map. In some embodiments, the image resizing step (134) is performed on an annotation map. In some embodiments, the removal of any individual connected component step (135) is performed on an annotation map. In some embodiments, the removal of the disc (136) is performed on an annotation map.

In some embodiments, the skeletonizing step (140) is configured to reduce the thickness of BV segments within an annotation map. In some embodiments, the skeletonizing step (140) maintains the essential connectivity and topology of the BV map. In some embodiments, the skeletonizing step (140) is configured to generate a thin topological map (referred to herein as “skeletonization map”) representing the original shape and structure of the blood vessels. In some embodiments, the thin topological map is characterized by a thickness of 1 pixel. In some embodiments, the skeletonizing step (140) is performed on the annotation maps and generates a skeletonization map.

In some embodiments, the preprocessing step (120) further comprises a graph creation step (142). In some embodiments, the graph creation step (142) is performed on a skeletonization map. In some embodiments, the graph creation step (142) comprises a removal of self-loops step (144) and a removal of small edges step (146). In some embodiments, the removal of self-loops (144) and the removal of small edges step (146) are performed on a skeletonization map.

In some embodiments, the removal of self-loops step (144) refers to an edge connecting a node to it-self. In some embodiments, the removal of small edges step (146) is performed after the skeletonizing step (140). In some embodiments, the removal of small edges step (146) is performed before the skeletonizing step (140).

In some embodiments, the removal of small edges step (146) refers to the removal of edges characterized by a ratio between the edge length and the image section of at least 0.02, at least 0.025, at least 0.03 at least 0.035 or at least 0.4, including any value in between. In some embodiments, the removal of small edges step refers to the removal of edges characterized by a ratio between the edge length and the image section of between 0.02 and 0.06, between 0.025 and 0.055, between 0.03 and 0.5, or between 0.035 and 0.045, including any range in between. In some embodiments, the removal of small edges step (146) refers to the removal of edges characterized by a ratio between the edge length and the image section of at least 0.02, at least 0.025, at least 0.03 at least 0.035 or at least 0.4 and between 0.02 and 0.06, between 0.025 and 0.055, between 0.03 and 0.5, or between 0.035 and 0.045, including any range or value in between. In some embodiments, the removal of small edges step (146) refers to the removal of edges characterized by a ratio between the edge length and the image section of about 0.04.

In some embodiments, the fragmenting step (150) comprises a graph node blackening step (154). In some embodiments, the graph node blackening step (154) refers to blackening the area around a node, removing the areas around the node. A skilled person in the art would appreciate that the number of pixels blackening the area around the node affects the fragments generated in graph. Removing a small number of pixels may result in a connection between segments that were not originally connected, while removing a large number of pixels may lead to the removal of an entire segments. In some embodiments, non-limiting examples for the blackening area around the node include but are not limited to 12, 13, 14, 15, 16, 17, 18, 19, or 20. In some embodiments, the blackening area around the node is 15 pixels.

In some embodiments, the fragmenting step (150) further comprises a small object removal step (156). In some embodiments, the removal of small objects step (156) refers to an object having a ratio between the object length and the image section of at least 3×10⁻⁴, at least 3.5×10⁻⁴, at least 4×10⁻⁴, or at least 4.5×10⁻⁴, including any value in between. In some embodiments, the removal of small objects step (156) refers to an object having a ratio between the object length and the image section of between 3×10⁻⁴ and 5×10⁻⁴, between 3.5×10⁻⁴ and 4.5×10⁻⁴, or between 3.75×10⁻⁴ and 4.25×10⁻⁴, including any range in between. In some embodiments, the fragmenting step (150) further comprises a small object removal step (156). In some embodiments, the removal of small objects (156) refers to an object having a ratio between the object length and the image section of at least 3×10⁻⁴, at least 3.5×10⁻⁴, at least 4×10⁻⁴, or at least 4.5×10⁻⁴, and between 3×10⁻⁴ and 5×10⁻⁴, between 3.5×10⁻⁴ and 4.5×10⁻⁴, or between 3.75×10⁻⁴ and 4.25×10⁻⁴, including any range or value in between. In some embodiments, the removal of small objects (156) refers to an object having a ratio between the object length and the image section of about 4×10⁻⁴.

In some embodiments, the fragmenting step (150) is performed on an annotation map. In some embodiments, the graph node blackening step (154) is performed on an annotation map. In some embodiments, the small object removal step (156) is performed on an annotation map.

In some embodiments, the overlaying step (160) of the BV map on top of a vein map, artery map, or both is configured to determine if the given segment is a vein or an artery. In some embodiments, the determination is by a pixel count, wherein the pixels of each segment in the artery and vein maps are counted. In some embodiments, a blood vessel is defined as an artery or a vein according to which element (vein or artery) has a greater pixel count of the segment. For example, if a given segment in a BV map, is characterized by 10 pixels in a vain map and 15 pixels in an artery map, the segment in the BV map is determined as an artery.

In some embodiments, the method further comprises a re-adding step (164) configured to add the blackening area around the node that were previously remove in the fragmenting step, in the BV map.

In some embodiments, the method further comprises a re-adding step (164) of the removed areas around the nodes. In some embodiments, the re-adding step (164) is performed after the overlaying step (160). In some embodiments, the re-adding step (164) is performed on an annotation map.

In some embodiments, the method further comprises an additional removal of small object step (166).

In some embodiments, the method further comprises a generating step, prior to the receiving step of the annotation maps. In some embodiments, the maps are generated from the image using different algorithms configured to generated BV map, vein map, artery map and/or disc map. In some embodiments, the generating step is configured to generate the annotation maps (BV, vein, and artery maps) through image processing techniques. In some embodiments, the image processing techniques focus on identifying and highlighting regions associated with BV in the image. In some embodiments, non-limiting examples of processing techniques include but are not limited to: Thresholding and morphological operations, vessel filters, segmentation algorithms, Hough transform, graph-based methods, active counter models, or ensemble approach, segmentation via neural networks including any combination thereof. In some embodiments, the image is a retinal image. In some embodiments, the processing technique is or comprises segmentation via neural networks.

In some embodiments, the method is configured to correct erroneous classifications made by a Natural network. In some embodiments, the Natural network generated the veins and arteries maps. In some embodiments, the method results in a substantially more accurate BV map compared to a BV map generated by processing techniques known today, for example, Thresholding and morphological operations, vessel filters, segmentation algorithms, Hough transform, graph-based methods, active counter models, or ensemble approach.

In some embodiments, the method is performed at least in part using at least one electronic for example forming part of a computer or other processing system, which may be a stand-alone processing system, or part of a cloud or server-based architecture.

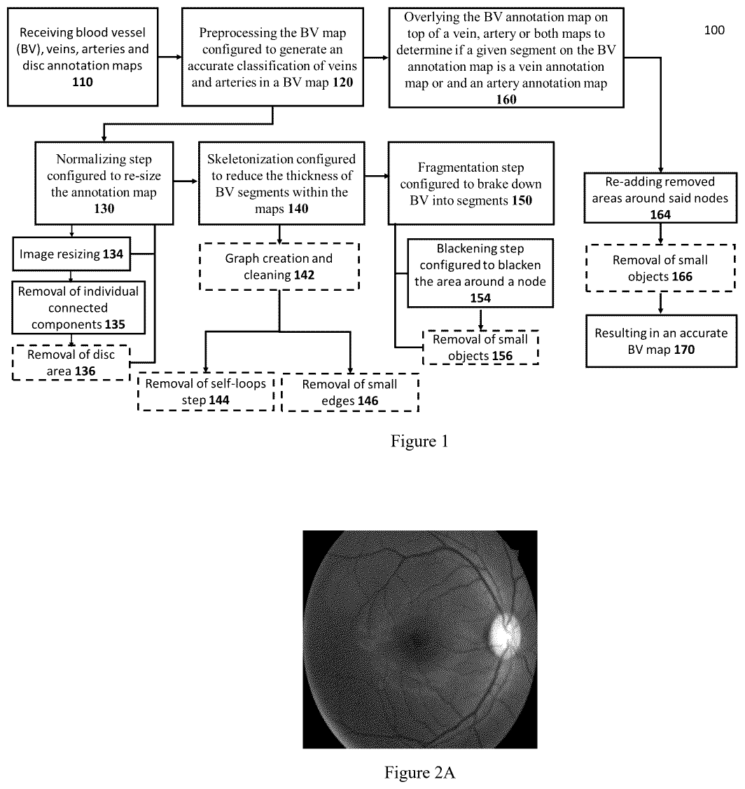

Reference is now made to FIG. 1, presenting an exemplary flow chart 100, according to some embodiments of the invention. The method receives four different annotation maps, optic disc, artery, vein, and BV annotation maps (110). The four annotation maps are then normalized (130). The normalizing step comprises an image resizing step configured to re-size the original annotation maps (134). Optionally, the normalization step further comprises the removal of the disc area (136) from the BV annotation map, and optionally from the vein and artery annotation maps. Then, the normalized BV annotation map, and optionally the artery and the vein annotation maps are skeletonized (140). The skeletonizing step is configured to reduce the thickness of the blood vessel segments within the annotation map. Optionally, the skeletonized annotation map is used to create a graph (142), and a cleaning process is performed. The cleaning process optionally comprises two steps, (i) removal of self-loops step (144) and (ii) removal of small edges step (146).

The skeletonized BV annotation maps, and optionally the artery and the vein annotation maps are then fragmentized (150). The fragmenting step comprises a blackening step (154) and optionally, the removal of small objects step (156). The BV annotation map is overlayed (160) with the vein annotation map, the artery annotation map, or both and the segments within the BV annotation maps are identified as a vein or an artery. Then, a re-adding step (164) is conducted, where the area around the nodes which were removed in the blackening steps are added to the resulted identified BV annotation map, resulting in an accurate BV annotation map (170).

Optionally, removal of small object step (166) is performed after the re-adding step (164) to decrease the signal-to-noise obtained in the accurate BV annotation map. In some embodiments, the skeletonizing step (140) is performed on an annotation map. In some embodiments, the fragmenting step (150) is configured to reduce the processing time of the overlaying step. In some embodiments, the fragmenting step reduces the signal to noise within the resulting annotation map. In some embodiments, all four annotation maps, BV, vein, disc and artery annotation maps, are re-sized. In some embodiments, the steps following the image resizing step are conducted on the re-sized BV annotation map. In some embodiments, the steps following the image resizing step are optionally conducted on the re-sized vein and re-sized artery annotation maps. In some embodiments, the fragmented BV annotation map is overlayed with a re-sized vein and artery annotation map. In some embodiments, the fragmented BV annotation map is overlayed with a re-sized, skeletonized vein and artery annotation map. In some embodiments, the fragmented BV annotation map is overlayed with a re-sized, fragmented vein and artery annotation map. In some embodiments, the fragmented BV annotation map is overlayed with a re-sized, skeletonized, and fragmented vein and artery annotation map.

In some embodiments, identified BV annotation map refers to the annotation map obtained after the identification of vein and artery in the overlaying step. In some embodiments, the method further comprises a generating step prior to receiving the annotation maps. In some embodiments, the generating step is configured to generate an annotation map from a retinal image.

According to another aspect of the invention there is disclosed a system for generating an accurate BV annotation map (i) a computer-implemented method (100) for accurately classifying veins and arteries in a blood vessel (BV) annotation map; (ii) a computer or hardware platform for running the computer-implemented method (100); (iii) a graphic processing unit having high computational power and resources to execute algorithms; and (iv) display monitor for visualizing the generated BV annotation map.

In some embodiments, the computer-implemented method (100) comprises (i) receiving (110) BV annotation map, veins annotation map, arteries annotation map and disc annotation map; (b) processing (120) the BV annotation map; and (c) overlaying (160) the BV map on top of a vein, artery, or both maps to determine if a given segment on the BV annotation map is a vein or an artery; wherein the preprocessing step (120) comprises (i) normalizing (130) the annotation maps; (ii) skeletonizing (140) the BV annotation map, and optionally the arteries and the veins annotation maps; and (iii) fragmenting (150) the BV annotation map, and optionally the arteries and veins annotation maps.

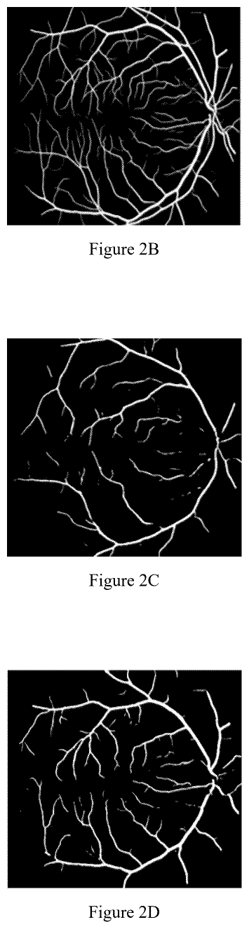

Reference is now made to FIGS. 2A-6, demonstrating annotation maps in different stages of the processing method of the invention, according to some embodiments of the invention.

FIG. 2A shows an exemplary retinal image. In some embodiments, retinal images are obtained by various imaging technologies. In some embodiments, the retinal image is used to generate the required annotation maps, blood vessel vein, artery, and optic disc annotation maps. A person skilled in the art would appreciate that the generation of an annotation map is performed using different algorithms, depending on the specific map that needs to be generated. FIGS. 2B-2E show (2A) BV annotation map, (2C) artery annotation map, (2D) vein annotation map, and (2E) optic disc annotation map, generated from the retinal image seen in FIG. 2A.

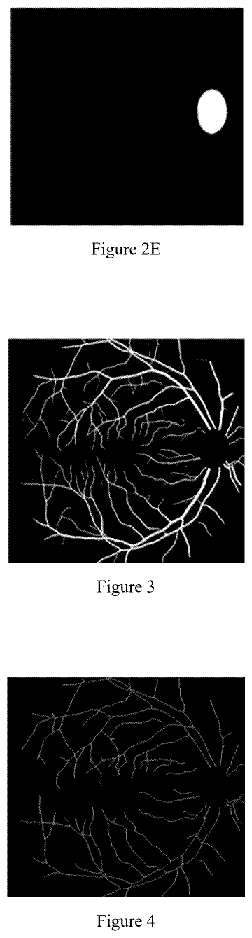

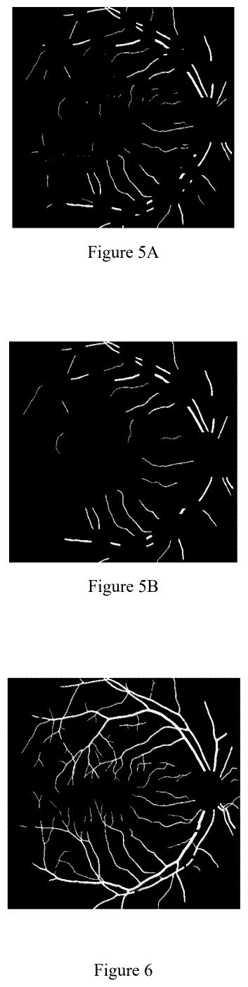

FIG. 3-FIG. 6 demonstrate the resulting exemplary BV annotation maps during different stages of the method presented in the present invention. FIG. 3A presents the BV annotation map obtained after the removal of the optic disc. In some embodiments, the removal of the optic disc is performed during the preprocessing step. FIG. 4 shows the annotation map obtained after the skeletonizing step. FIGS. 5A-5B show the resulting BV annotation map after the fragmenting step, FIG. 5A after the blackening step, and FIG. 5B after the removal of small objects. FIG. 6 is an exemplary blood vessel annotation map obtained by the method of the invention. The single-to-noise ratio and accuracy in the identification of the blood vessel as an artery or a vein is greater when compared to the BV annotation map obtained by algorithms used today, for example FIG. 2B. The method of the invention identifies veins and arteries more accurately in a blood vessel annotation map. In some embodiments, the increased accuracy in identification enhances the ability to diagnose more accurately and in early stages different medical conditions, disease and/or disorders.

While the inventive concept has been described with reference to exemplary embodiments thereof, it will be apparent to those of ordinary skill in the art that various changes and modifications may be made thereto without departing from the spirit and scope of the inventive concept as set forth in the following claims.

1. A method (100) for generating an accurate classification of veins and arteries in a blood vessel (BV) annotation map comprising steps of:
a. receiving (110) BV annotation map, veins annotation map, arteries annotation map, and disc annotation map;
b. preprocessing (120) said annotation maps configured to generate an accurate classification of veins and arteries in a BV annotation map; and
c. overlaying (160) said BV map on top of a vein, artery, or both maps to determine if a given segment on said BV annotation map is a vein or an artery;
wherein said preprocessing step (120) comprises
i. normalizing (130) said annotation maps;
ii. skeletonizing (140) said BV annotation map, said arteries annotation map or said veins annotation map, including any combination thereof; and
iii. fragmenting (150) said BV annotation map, said arteries annotation map or said veins annotation map, including any combination thereof.

2. The method of claim 1, wherein said method corrects classification errors of veins, arteries, or both in said BV map.

3. The method of claim 1, wherein said annotation maps are produced from a retinal image, by algorithms configured to generate said BV annotation map, said veins annotation map, said arteries annotation map, and said disc annotation map, including any combination thereof.

4. The method of claim 1, wherein said normalizing (130) comprises an image resizing step (134).

5. The method of claim 4, wherein said normalizing step (130) further comprises a removal step of disc area (136) from said BV map using a disc annotation map.

6. The method of claim 1, wherein said fragmenting step (150) comprises a graph node blackening step (154).

7. The method of claim 6, wherein said fragmenting step (156) further comprises a removal of small object step.

8. The method of claim 1, wherein said preprocessing step (120) further comprises a graph creation and a cleaning step (142).

9. The method of claim 1, wherein said graph creation and cleaning step (142) comprises a removal of self-loops step (144), a removal of small objects step (146), or both.

10. The method of claim 1, wherein said method further comprises a re-adding step (164) configured to add removed areas around said nodes.

11. The method of claim 1, wherein said method further comprises removal of small objects step (166) from resulted BV map.

12. The method of claim 1, wherein said determination is done by segment pixel count.

13. A system for generating an accurate classification of veins and arteries in a blood vessel (BV) annotation map comprising
a. computer-implemented method (100) for accurately classifying veins and arteries in a blood vessel (BV) annotation map;
b. a computer or hardware platform for running said software;
c. a graphic processing unit having high computational power and resources to execute algorithms; and
d. display monitor for visualizing said generated BV annotation map.

14. The system of claim 13, wherein said computer-implemented method (100) comprises
a. receiving (110) BV annotation map, veins annotation map, arteries annotation map and disc annotation map;
b. processing (120) said annotation maps; and
c. overlaying (160) said BV map on top of a vein annotation map, artery annotation map, or both maps to determine if a given segment on said BV annotation map is a vein or an artery;
wherein said preprocessing step (120) comprises
i. normalizing (130) said annotation maps;
ii. skeletonizing (140) said BV annotation map, said arteries annotation map or said veins annotation map, including any combination thereof; and
iii. fragmenting (150) said BV annotation map, said arteries annotation map or said veins annotation map, including any combination thereof.

15. The system of claim 13, wherein said computer-implemented method (100) corrects classification errors of veins, arteries, or both in said BV map.

16. The system of claim 14, wherein said normalizing step (130) comprises an image resizing step (134), and optionally a removal step of disc area (136) from said BV map using a disc annotation map.

17. The system of claim 14, wherein said fragmenting step (150) comprises a graph node blackening step (154), and optionally a removal of small object step (156).

18. The system of claim 14, wherein said preprocessing step (120) further comprises a graph creation and a cleaning step (142); said graph creation and cleaning step comprises a removal of self-loops step (144), a removal of small objects step (146), or both.

19. The system of claim 13, wherein said computer-implemented method further comprises a re-adding step (164) configured to add removed areas around said nodes, a removal of small objects step (166) from resulted BV map, or both.

20. The system of claim 13, wherein said determination is done by segment pixel count.
